(19) United States
(12) Patent Application Publication
(10) Pub. No.: US 2013/0219771 A1
(43) Pub. Date: Aug. 29, 2013

(54) Bed Bug Monitoring Device

(71) Applicants: Bruce Black, Yardley, PA (US); Shreya Sheth, Levittown, PA (US); Linda Varanyak, Mercerville, NJ (US); Keith Woodruff, Mountainside, NJ (US)

(72) Inventors: Bruce Black, Yardley, PA (US); Shreya Sheth, Levittown, PA (US); Linda Varanyak, Mercerville, NJ (US); Keith Woodruff, Mountainside, NJ (US)

(73) Assignee: FMC Corporation, Philadelphia, PA (US)

(21) Appl. No.: 13/819,358

(22) PCT Filed: Aug. 29, 2011
(86) PCT No.: PCT/US11/49544

§ 371 Date: May 15, 2013

Related U.S. Application Data
(60) Provisional application No. 61/378,546, filed on Aug. 31, 2010.

(51) Int. Cl. A01M 1/10; A01M 1/14

(52) U.S. Cl. CPC A01M 1/103; A01M 1/14
USPC 43/114; 43/123; 43/132.1

(57) ABSTRACT

The invention is directed to a bed bug monitoring device comprising a bed bug attractant element and a harborage section comprising a support member having a traversable surface and one or more protuberances depending therefrom. The harborage defines at least one entrance through which bed bugs attracted to the device can enter. The device can further include a base section placed over at least a portion of the traversable surface and adapted to by placed flush with the surface against which the device is to be placed.

### FIELD OF THE INVENTION

In one aspect, the present invention relates to a bed bug monitoring device. In another aspect, this invention relates to an insect traversable surface and methods for producing the same.

### BACKGROUND OF THE INVENTION

Bed bugs are small nocturnal insects of the family Cimicidae that feed off the blood of humans and other warm blooded hosts. Bed bugs exhibit cryptic behavior, which makes their detection and control difficult and time consuming. This is particularly true for the common bed bug, Cimex lectularius, which has become well adapted to human environments. Other species of bed bugs are nuisances to people and/or animals as well.

While bed bugs have been controlled in many areas, such as the United States, the increase in international travel has contributed to a resurgence of these pests in recent years. There are many aspects of bed bugs which make it difficult to eradicate them once they have established a presence in a location. Accordingly, there is a need for effective traps to determine the presence of bed bugs before they become entrenched.

Adult bed bugs are about 6 millimeters long, 5 to 6 millimeters wide, and are reddish brown with oval, flattened bodies. The immature nymphs are similar in appearance to the adults, but are smaller and lighter in color. Bed bugs do not fly, but can move quickly over surfaces. Female bed bugs lay their eggs in secluded areas and can deposit up to five eggs per day, and as many as 500 during a lifetime. The bed bug eggs are very small, about the size of a dust spec. When first laid, the eggs are sticky causing them to adhere to surfaces.

Bed bugs can go for long periods of time without feeding. Nymphs can survive for weeks without feeding, while adults can survive for months. Consequently, infestations cannot be eliminated simply by leaving a location unoccupied for brief periods of time. Further, such feeding habits make it difficult to monitor whether bed bugs are present as they may only be attracted to bait when hungry. Thus, in order to be effective, a bed bug capturing device must be able to generate attractants at an effective concentration for an extended period of time.

While bed bugs are active during the nighttime, during daylight they tend to hide in tiny crevices or cracks. Bed bugs may therefore find easy hiding places in beds, bed frames, furniture, along baseboards, in carpeting and countless other places. Bed bugs tend to congregate but do not build nests like some other insects.

Bed bugs obtain their sustenance by drawing blood through elongated mouth parts. They may feed on a human for 3 to 10 minutes, although the person is not likely to feel the bite. After the bite, the victim often experiences an itchy welt or a delayed hypersensitivity reaction resulting in a swelling in the area of the bite. However, some people do not have any reaction or only a very small reaction to a bed bug bite. Bed bug bites have symptoms that are similar to other pests, such as mosquitoes and ticks. It is not possible to determine whether a bite is from a bed bug or another type of pest; and bites may be misdiagnosed as hives or a skin rash. Consequently, bed bug infestations may frequently go on for long periods before they are recognized.

Bed bug infestations originate by a bed bug being carried into a new area. Bed bugs are able to cling to possessions and hide in small spaces, such that they may be transported in a traveler's belongings. As a result, buildings where the turnover of occupants is high, such as hotels, motels, inns, barracks, cruise ships, shelters, nursing homes, camp dwellings, dormitories, condominiums and apartments, are especially vulnerable to bed bug infestations.

Because of all the features of bed bugs described herein, bed bugs are both difficult to detect and eradicate. Professional pest removal specialists and pesticides are needed. It is necessary to remove all clutter and unnecessary objects from a room, remove bed bugs and eggs as much as possible through vacuuming, and apply pesticides to likely hiding areas. This type of treatment for eradication can be disruptive to a business such as a hotel. As a result, it is desirable to detect bed bugs at the earliest possible moment before an infestation becomes established.

The tiny, mobile and secretive behavior of bed bugs makes it nearly impossible to prevent and control an infestation unless they are quickly discovered and treated. Bed bugs have been found to move through holes in walls, ceilings and floors into adjacent rooms. Devices and methods for the early detection of bed bugs are especially needed in the hospitality industries.

While several attempts have been made to devise bed bug monitoring devices in the past, these devices have, in general, not proven to be commercially effective. The present inventors have studied many aspects of bed bug behavior, and believe that one factor in the failure of such devices to desirably perform is the lack of an effective trapping mechanism.

Thus, it has been observed by the present inventors that bed bugs, unlike many other insect pests, are resistant to many types of sticky traps, having the ability to cross traps that would snare other insects, particularly where a heating element is not employed. Consequently, bed bug monitors that rely upon luring bed bugs to sticky traps may not be effective as the bed bugs may simply walk across the trap surface and eventually exit the device.

Further, bed bugs are extremely sensitive to the roughness of the surfaces on which they are placed. Bed bugs tend to avoid crossing smooth surfaces, rendering current traps which require such a traversal before they are trapped ineffective. Indeed, it has been unexpectedly found that traps having a textured surface which are effective to trap/monitor other insect species are (when modified to contain a bed bug attractant) ineffective to trap/monitor bed bugs as their surface is apparently too smooth for the bed bugs despite such outwardly rough appearance.

Moreover, it has been observed that even when a bed bug capturing device contains an otherwise effective trapping mechanism such as a deadfall trap, the cryptic behavior of bed bugs can frustrate the effective performance of such device.

Specifically, it has been observed that the bed bugs attracted to a monitor will frequently crawl between the device and the surface upon which it is positioned (such as a floor or a wall) rather than entering into a channel leading to an internal deadfall trap where their presence can be confirmed. As is discussed above, it is important to detect the presence of bed bugs in a room as early as possible in order to avoid having an infestation become established. Consequently, there is a need for a bed bug monitoring device which will effectively capture those bed bugs attracted by the attractant element thereof. Further, there is a need for a bed bug monitoring device which can be quickly and easily be inspected to determine if bed bugs are present.

### SUMMARY OF THE INVENTION

In one aspect, the present invention is directed to a bed bug monitoring device comprising a bed bug attractant element and a harborage comprising a support member having a traversable surface and one or more protuberances thereon. The harborage is adapted to be placed flush with the surface where the device will be placed. The harborage can define at least one entrance through which bed bugs attracted to the device can enter. In an aspect of the invention the protuberances define one or more channels. The one or more channels can be positioned such that bed bugs attracted to the device can enter into the one or more channels. In a further aspect of the invention the traversable surface has an average surface roughness of at least about 2.5 micrometers.

In another aspect, the invention is directed to a method for providing a traversable surface for bed bugs comprising the steps of (a) applying a binder mixture comprising (i) an adhesive and (ii) a solid to the surface of a support member and drying the mixture. Preferably, the solid is a particulate solid. A further aspect of the invention comprises a traversable surface for bed bugs comprising a support member having a surface at least partially coated with a mixture comprising an adhesive and a particulate solid. In an aspect of the invention the coated surface has an average surface roughness of at least about 2.5 micrometers.

In a still further aspect, the present invention is directed to a bed bug monitoring device comprising: (a) a bed bug attractant element; and (b) a harborage comprising: (i) a base section, at least a portion of which can be composed of a transparent material, the base section being adapted to be placed flush with the surface against which the device is to be placed; and (ii) a support member having a traversable surface and one or more protuberances depending therefrom. The harborage defines at least one entrance through which bed bugs attracted to the device can enter. The one or more protuberances define one or more channels, which one or more channels are positioned such that bed bugs entering the device through the at least one entrance can enter into the one or more channels. At least a portion of the traversable surface is an exposed area possessing an average surface roughness of at least about 2.5 micrometers.

In another aspect, this invention is directed to a method for providing a traversable surface for bed bugs comprising the steps of (a) applying a binder mixture comprising (i) a water-based adhesive and (ii) a particulate solid, to the surface of a support member; and (b) drying the mixture; such that the average surface roughness of the surface is at least about 2.5 micrometers.

### DESCRIPTION OF THE DRAWINGS

FIG. 1 is a perspective view of one embodiment of the bed bug monitoring device of this invention.

FIG. 2 is a cross-sectional view of the monitoring device of FIG. 1.

FIG. 3 is an enlarged view of a cross section of the harborage of the monitoring device of FIG. 1.

FIG. 4 is a bottom view of the monitoring device of FIG. 1.

FIG. 5 is a graph of data obtained by the testing conducted in Example 1.

### DETAILED DESCRIPTION OF THE INVENTION

In one aspect, the present invention is directed to a bed bug monitoring device comprising a bed bug attractant element and a harborage comprising a support member having a traversable surface and one or more protuberances thereon. By “traversable surface” it is meant to include any suitable surface which bed bugs can move across. Preferably, the traversable surface has a surface roughness of at least about 2.5 micrometers. The harborage is adapted to be placed flush with the surface where the device will be placed. The harborage can define at least one entrance through which bed bugs attracted to the device can enter. In an aspect of the invention the protuberances define one or more channels. The one or more channels can be positioned such that bed bugs attracted to the device can enter into the one or more channels.

In another aspect, the invention is directed to a method for providing a traversable surface for bed bugs comprising the steps of (a) applying a binder mixture comprising (i) an adhesive and (ii) a solid to the surface of a support member and drying the mixture. Preferably, the solid is a particulate solid. In a further aspect of the invention the adhesive comprises a water-based adhesive. A further aspect of the invention comprises a traversable surface for bed bugs comprising a support member having a surface at least partially coated with a mixture comprising an adhesive and a particulate solid. In an aspect of the invention the coated surface has an average surface roughness of at least about 2.5 micrometers.

In one aspect, the present invention is directed to a bed bug monitoring device comprising: (a) a bed bug attractant element; and (b) a harborage comprising: (i) a base section, at least a portion of which can be composed of a transparent material, the base section being adapted to be placed flush with the surface against which such device is to be placed; and (ii) a support member having a traversable surface and one or more protuberances depending therefrom. The harborage defines at least one entrance through which bed bugs attracted to the device can enter. The one or more protuberances define one or more channels, which one or more channels are positioned such that bed bugs entering the device through the at least one entrance can enter into the one or more channels. Moreover, at least a portion of the traversable surface is an exposed area possessing an average surface roughness of at least about 2.5 micrometers.

In another aspect, this invention is directed to a method for providing a traversable surface for bed bugs comprising the steps of (a) applying a binder mixture comprising a water-based adhesive and a particulate solid to the surface of a support member; and (b) drying the binder mixture; such that the average surface roughness of the surface is at least about 2.5 micrometers.

The bed bug attractant element employed in the monitoring device of this invention may comprise any bed bug attractant which is effective to lure the bed bugs into the device such that they enter into the pathway of the deadfall element and follow the path until they become trapped in the trap area. Attractants which may be employed include carbon dioxide, heat, pheromones, human sweat components and the like, all of which are known to those of skill in the art. Mixtures of one or more attractants may also be employed.

Preferably, the attractant employed comprises at least one member of the group consisting of organic acids and aldehydes; and more preferably comprises at least one member of the group consisting of butyric acid, trans-2-hexen-1-al (Hexenal) and trans-2-octen-1-al (Octenal).

One particularly preferred attractant comprises an unsaturated aldehyde component and an organic acid component. It is preferred that the unsaturated aldehyde component be comprised of one or more aldehydes selected from the group consisting of Hexenal and Octenal. It is preferred that the organic acid component be butyric acid. When the aldehyde component is comprised of both Hexenal and Octenal, it is preferred that the aldehydes be present in a ratio of from about 1:5 and about 5:1 of Hexenal to Octenal, more preferably in a ratio of between about 3:1 and about 1:3. In order to be most attractive to bed bugs, the optimal concentration of the Hexenal and Octenal mixture to be released is from about 50 ng/L/hr to about 200 ng/L/hour, and the optimal concentration of butyric acid to be released is between about 15 ng/L/hr and about 50 ng/L/hr. Mixing butyric acid with Hexenal and Octenal forms an unstable composition and it is necessary to separate the aldehyde component from the acid component. In order for the separate components of the attractant composition to be released at the proper rates, each component may be dissolved in an organic solvent, for example a C₈-C₁₂ alkane. For applications in which the device may be subjected to temperature fluctuations between about 20° C. and 40° C., decane and undecane are particularly preferred solvents as their rate of volatilization is less affected by such temperature fluctuations than is nonane.

In one aspect of the invention suitable attractants comprise octenal dissolved in decane at a concentration range of about 2000 to 3000 ppm octenal, preferably from about 2500 to 2800 ppm octenal, and more preferably from about 2700 to 2750 ppm octenal. A second suitable attractant that can be used in conjunction with the octenal is butyric acid dissolved in decane at a concentration range of about 200 to 2000 ppm butyric acid, and preferably from about 240 to 400 ppm butyric acid.

Each component may be incorporated into an absorbent material, for example, but not limited to cotton batting, fiberized cellulose wood pulp, synthetic batting, polyester batting, felt, bonded carded webs, very high density polyethylene sponge and high loft spunbond materials. In order to regulate diffusion, a semi-permeable membrane can be used to encase the absorbent materials. The attractant components can be dispensed from containers with either a semi-permeable top or a sealed top containing one or more holes to allow diffusion into the surrounding atmosphere.

In one embodiment the attractant is contained in an ampoule comprising an outer shell composed of an impermeable material, and defining at least one opening, and a film member adhered to said outer shell and covering said at least one opening.

In one particularly preferred embodiment, the ampoule comprises an outer shell composed of an impermeable material defining at least one opening; a porous diffusion member defining an internal reservoir positioned inside said outer shell; a volatile liquid comprising the attractant contained within the internal reservoir; and a film member adhered to said outer shell and covering said at least one opening; wherein said film member is disposed such that an air space is present between said porous diffusion member and said film member; and wherein said porous diffusion member is configured such that molecules of the volatile liquid can only enter into said air space via diffusion through said porous diffusion member. The film member may be composed of a permeable material though which the attractant will diffuse at a desired rate; or it may be made of an impermeable material and define one or more holes of a predetermined size in order to release the attractant at a desired rate.

The attractant element of this invention may comprise one or more means of providing air flow such that the attractant is dispersed in quantities which will attract bed bugs. Any means which will produce the desired air flow may be employed including heat, compressed gas (particularly when carbon dioxide is employed as the attractant), air pumps, fans, and the like. When the attractant comprises a chemical attractant which is heavier than air which is not under compression, such as pheromones, organic acids or other attractants (including the mixed aldehyde/organic acid mixture described above), the preferred air movement means is a fan, such that the device has a face velocity of between about 5 and about 50 ml/cm²/min, more preferably of between about 10 and about 40 ml/cm²/min., and most preferably of between about 15 and about 35 ml/cm²/min.

In an aspect of the invention, the harborage of the bed bug monitoring device comprises (i) a base section and (ii) a support member having a traversable surface. Such harborage defines at least one entrance through which bed bugs attracted to the monitoring device can enter. Preferably, the at least one entrance is located at the base of the device such that bed bugs seeking to hide under the monitoring device will enter into the entrance without having to climb up an incline, ramp or similar structure.

At least a portion of the base section can be transparent, such that one can readily determine by visual inspection whether any bed bugs have entered into the harborage. The transparent portion may be made of any transparent material which does not repel bed bugs such as glass or a clear plastic such as polycarbonate. Polycarbonate is preferred as it may be easily welded to the support member when the support member is composed of a hard plastic material such as high impact polyethylene or acrylonitrile butadiene styrene.

The base section is shaped such that it is adapted to be placed flush with the surface against which the device is to be placed. Accordingly, the base section will be planar in most preferred applications such that the monitoring device can be placed flush against a wall, floor, or other suitable surface, depending upon the orientation of the device.

The support member having a traversable surface comprises one or more protuberances which depend outward from the surface. Such one or more protuberances define one or more channels which are of sufficient dimensions to permit a bed bug to crawl therein. Preferably, the protuberances are spaced to form channel widths of between about 2 mm and about 10 mm. In an aspect of the invention the protuberances are spaced to form channel widths of between about 3 mm and about 6 mm. The protuberances are preferably designed such that top portion of the channels formed thereby are concave in cross section. The protuberances should be of sufficient height such that bed bugs can crawl through the channels formed thereby without contacting the base section of the harborage. One or more of the protuberances may extend to be in contact with the base section of the harborage.

At least a portion of the exposed area of the traversable surface, and preferably the entire exposed area of the traversable surface possesses an average surface roughness of at least about 2.5 micrometers, preferably of at least about 3.0 micrometers. As is employed herein, the term “average surface roughness” means the arithmetic average height of roughness irregularities measured from a mean line within an evaluation length. The average surface roughness of a material can be measured using a Pocket Surf® portable surface roughness gage available from Mahr Federal Inc. Care must be taken when measuring the roughness of surfaces which are coated or filled with a soft material (such as talc or cellulose) as the diamond stylus of the gage may shear or flatten such soft material and produce a reading which does not accurately indicate the average surface roughness. Further, as is employed herein, the term “exposed area” refers to the surface portion of the traversable surface with which bed bugs may come into contact when they enter into the harborage. The one or more channels are positioned such that bed bugs entering the device through the at least one entrance can enter into the one or more channels.

The support member having a traversable surface may be comprised of any suitable material or materials which do not repel bed bugs. Preferred materials include hard plastics such as high impact polyethylene or acrylonitrile butadiene styrene. Other materials which may be employed include polychlorotrifluoroethylene, polyvinylidene chloride, high density polyethylene, polypropylene, cardboard, wax paper board, galvanized metal and aluminum.

If the surfaces of the materials used to construct exposed area of the support member having a traversable surface do not possess sufficient surface roughness, their surfaces can be modified by treating the surface with an abrasive material (such as sandpaper or a wire brush) or by adhering an appropriate material to the appropriate pathway surfaces (e.g., by gluing a cloth or paper to smooth plastic or metal). In one preferred embodiment at least a portion of the support member can be molded from a plastic (such as polyethylene or polypropylene) which contains a filler material (such as glass, glass particles or talc) which will provide an adequate surface roughness. In another preferred embodiment, the exposed area of the traversable surface is coated with a binder mixture comprising (i) a water-based adhesive and (ii) a particulate solid.

In one particularly preferred embodiment, the support member having a traversable surface is composed of a material such as acrylonitrile butadiene styrene, polyethylene or polypropylene; the exposed area of which has been coated with a binder mixture comprising: (i) a water-based adhesive and (ii) a particulate solid; and the base section is composed of a polycarbonate. The use of such a binder mixture provides a traversable surface with an adequate average surface roughness (of at least about 2.5 micrometers) without interfering with the welding together of the two sections.

The water-based adhesive employed may be based upon a natural polymer from vegetable sources (e.g. dextrins, starches), protein sources (e.g. casein, blood, fish, soybean, milk albumen), and animal (e.g. hides, bones), or may be based upon a soluble synthetic polymer including: polyvinyl alcohol, cellulose ethers, methylcellulose, carboxymethylcellulose, and polyvinylpyrrolidone.

Any particulate solid which provides a sufficient roughness and which does not repel bed bugs may be employed. Preferred solids include pumice, carborundum, kaolin, silica, sand, cellulose, talc and mixtures thereof. Kaolin is particularly preferred.

The water-based adhesive typically comprises between about 1% and about 70% by weight adhesive, balance water, more preferably between about 20% and about 60% by weight adhesive, balance water, and most preferably about 40% by weight adhesive, balance water. The particulate solid is typically present in an amount between about 1% and about 30% w/v, based upon the volume of the adhesive/water mixture. Preferably, the inert particulate will have an average particle size of between about 5 and about 50 micrometers.

In another aspect, this invention provides a traversable surface for bed bugs comprising the steps of (a) applying a binder mixture comprising (i) a water-based adhesive and (ii) a particulate solid, to the surface of a support member; and (b) drying the mixture; such that the average surface roughness of the surface is at least about 2.5 micrometers.

A sufficient amount of the binder mixture should be applied to adequately cover the surface which is to be rendered traversable. The binder mixture can be allowed to air dry or can be dried by other means, such as the application of heat.

The present invention may be better understood by reference to the attached Figures which are intended to be demonstrative of certain embodiments, but are not intended to be limiting of the scope of the invention in any manner.

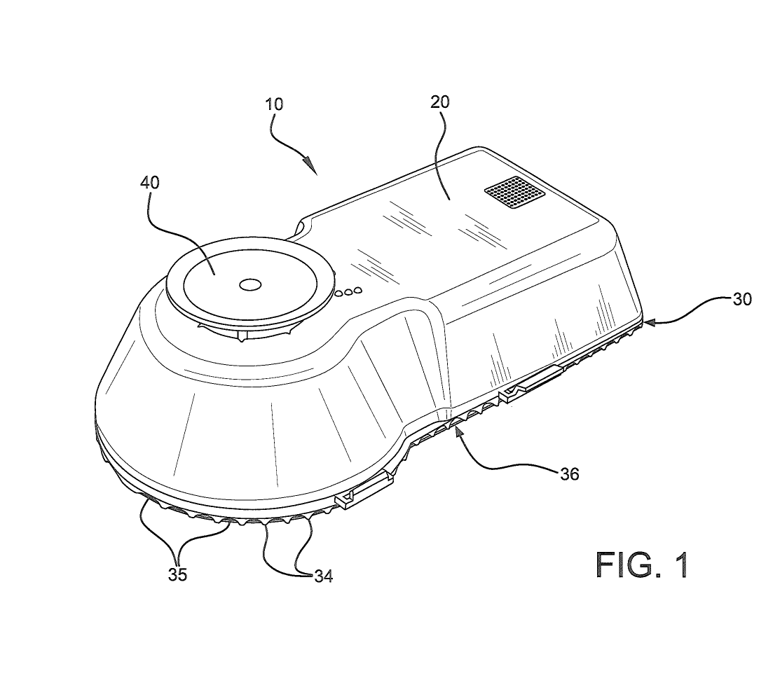

FIG. 1 is a perspective view of one embodiment of the bed bug monitoring device of this invention. Monitoring device 10 comprises cover housing 20, which contains an attractant element, placed over harborage 30. Optional rotatable top/actuator 40 extends from cover housing 20. Channels 35, which are connected to openings defined by the harborage such that bed bugs which are attracted to the device may crawl inside, are formed by protuberances 34 which extend from the support member of the harborage. Optional base section 36 of harborage 30 is adapted to be placed flush against the surface against which the device is to be placed. Although the device is shown positioned horizontally, it will be understood that the device can be positioned vertically with the base section of the harborage, or the harborage, being placed flush against a wall, or other vertical surface.

Cover housing 20 and rotatable top/actuator 40 may be made of any suitable material or materials which do not repel bed bugs. Preferred materials include plastics such as high impact polyethylene, polyethylene terephthalate and acrylonitrile butadiene styrene. It is preferred that the device be dark in color, for example shades of brown, shades of red, black, dark gray, navy blue, dark blue or deep violet as bed bugs tend to choose darker surfaces over lighter surfaces. In general, colors darker than a photographic gray card are preferred.

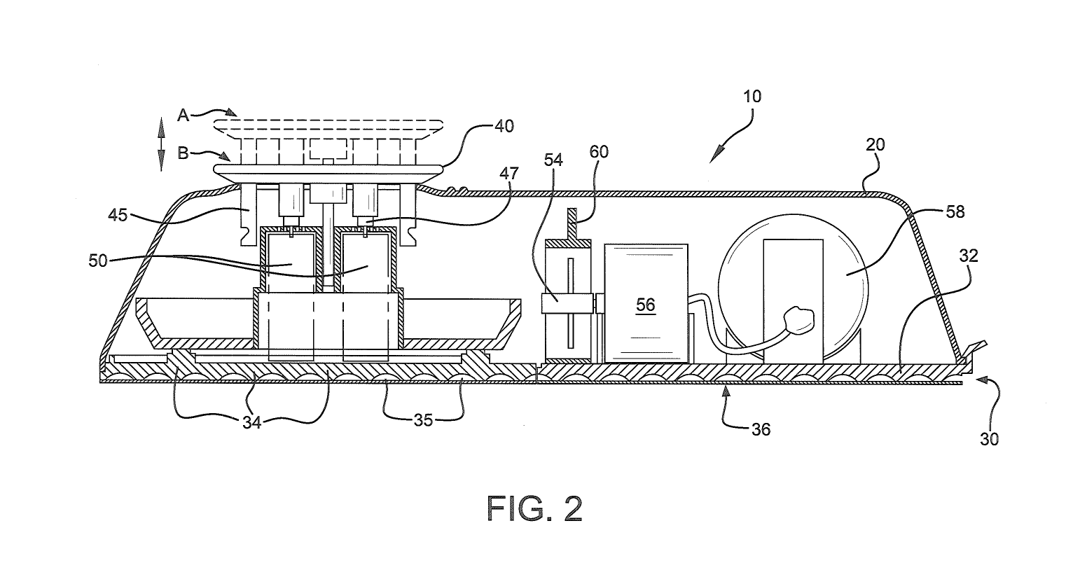

FIG. 2 is a cross-sectional view of the monitoring device of FIG. 1. Cover housing 20 contains an attractant element, and is located above harborage 30 which is comprised of support member 32 having a traversable surface and optional base section 36. Base section 36 can be made of a transparent material and is adapted to be placed flush against the surface against which the device is to be placed. When base section 36 is not used, traversable surface of the support member 32 is adapted to be placed flush against the surface. Support member 32 comprises protuberances 34 which define channels 35. Channels 35 are sufficiently wide and high such that bed bugs attracted to the device by the attractant element are able to crawl inside.

Monitoring device 10 comprises an attractant element which includes attractant receiving means 50, which can be adapted to house an attractant (e.g., a vial containing an attractant composition), and optional fan 54. Fan motor 56 is powered by battery 58. Air dam 60 helps to regulate the air flow from fan 54 such that the attractant is blown out of the monitor device at a desired surface velocity. Rotatable top/actuator 40 includes support members 45, as well as piercing members 47. The rotatable top/actuator 40, which can have a diameter larger than that of the opening in cover housing 20 in which it is inserted, can be rotated to a lower position such that piercing members 47 can puncture the metal foil tops of the polymer vials containing attractant composition(s) which have been placed into attractant receiving means 50. Cover housing 20 may be provided with a plurality of notches that can serve as stop points for support members 45 as the rotatable top/actuator 40 is rotated. The first point can serve as a starting point, where prior to use of the device the rotatable top/actuator 40 is locked in its upper position (line A in FIG. 2). To activate the device, the rotatable top/actuator 40 is rotated to the second point which serves as the piercing position. This position is designed such that the attractant receiving elements placed into attractant receiving means 50 are positioned underneath piercing elements 45. At this point, the rotatable top/actuator 40 can be depressed (to line B in FIG. 2) so that piercing elements 45 can puncture the metal foil tops of the polymer vials containing the attractant compositions. After piercing the metal foils, the rotatable top/actuator 40 can be placed back in the up position and rotated to the third point. The third point can serve as a locking position for use when the device is in operation. When in this position, the attractant composition can diffuse into the surrounding atmosphere. Fan 54 provides a desired air flow over the pierced metal foils to direct the lure compositions toward the opening in cover housing 20 under cover/actuator 40. Bed bugs attracted to the attractant will enter into harborage 30.

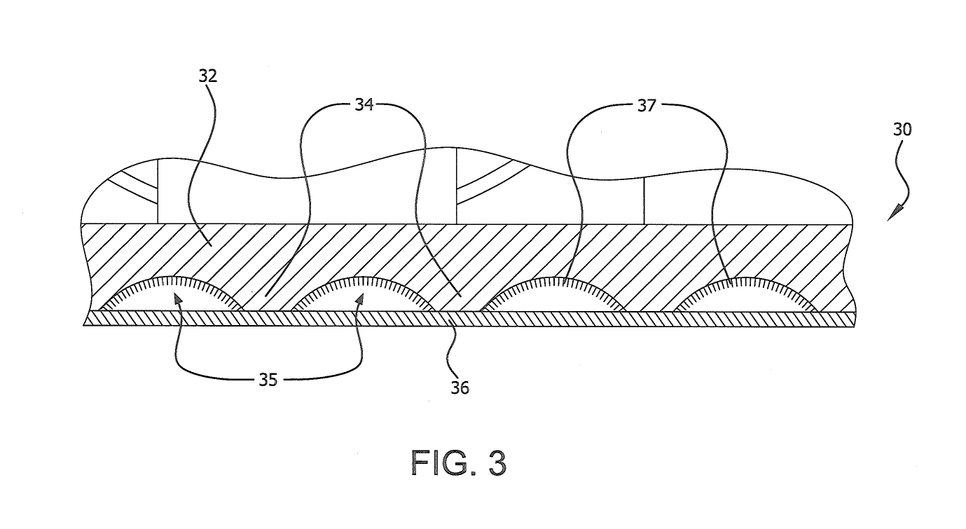

FIG. 3 is an enlarged view of a cross section of the harborage of the monitoring device of FIG. 1. Harborage 30 is comprised of a support member 32 having a traversable surface and optional base section 36. Channels 35 are defined by protuberances depending from support member 32 having a traversable surface. The outer portions of channels 35 are open to serve as entrances to the harborage. Exposed area(s) 37 of the traversable surface 32 possess an average surface roughness of at least about 2.5 micrometers. Preferably, such roughness is achieved by coating the exposed area with a binder mixture comprising an adhesive and a particulate solid. Preferably, the adhesive is a water-based adhesive.

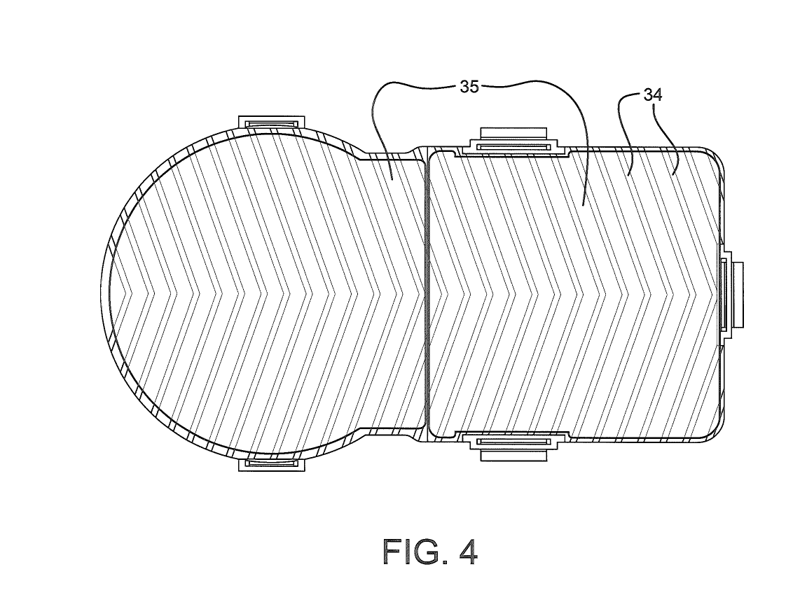

FIG. 4 is a bottom view of the monitoring device of FIG. 1. Channels 35, formed by protuberances 34 are clearly visible through the transparent base member. Accordingly, the presence of bed bugs in the channels can be determined by visual inspection simply by lifting up the device. Although a chevron pattern is shown, it will be appreciated by one of skill in the art that any pattern, including a maze which would make it more difficult for the bed bugs to exit the harborage, may be employed.

### EXAMPLES

### Example 1

A test arena was constructed from a 60×40×22 cm (L:W:H) polystyrene container. A 60×40 cm piece of filter paper was glued on the bottom to provide a walking surface for the bed bugs. At one end of the test arena, a triangular piece of plastic (16 cm high×25 cm long) was glued to the middle of the side and bottom of the container to create a partition of equal area on either side of the partition. On each side of this partition a piece of Tygon® tubing was positioned through a cover to deliver compressed air downward at a predetermined velocity into a base which functioned as a bed bug trap area. The gap between the top and bottom of the deadfall area was 2.5 mm.

The control trap did not contain any lure, while the test trap contained two one hundred micro Liter pipettes. One end of each pipette (Drummond Wiretrol 100 μL) was sealed with parafilm while the other end was left open. The first pipette contained a 300 ppm solution containing Hexenal and Octenal in a 75:25 weight ratio, prepared by dissolving the aldehydes in decane. The second pipette contained a 200 ppm solution of butyric acid in nonane.

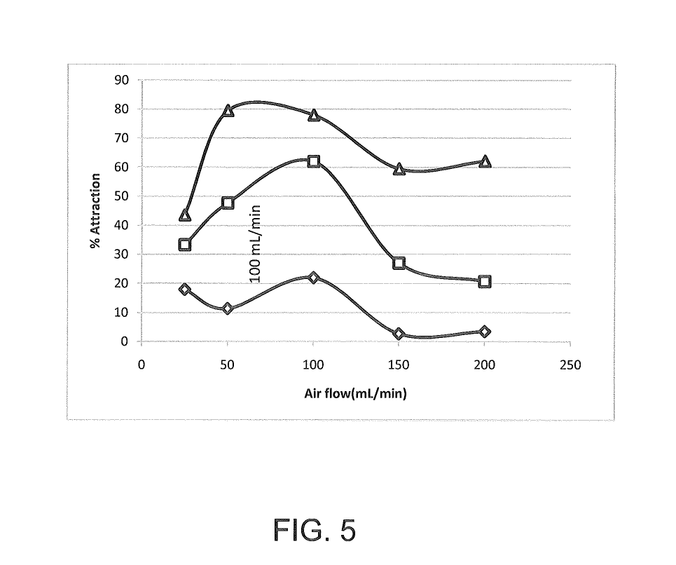

Fifty bed bugs (Cimex lectularius) were entrapped within an inverted 90 mm Petri dish at a position furthest from the control and experimental zones until the bed bugs were quiescent. Removal of the Petri dish started the experiment and readings were taken after 2 hours. The results of such testing are shown graphically in FIG. 5.

In the graph of FIG. 5, the triangles indicate the number of bed bugs in the experimental zone; the squares indicate the number of bed bugs in, on or under the trap; and the diamonds indicate the number of bed bugs in the trap.

The data shows that, even under the most effective conditions, only a relatively small percentage of the bed bugs actually entered into the deadfall trap.

### Example 2

Employing an arena similar to the one described in Example 1, a series of experiments were conducted employing a bed bug monitor having a harborage similar to that shown in FIGS. 1-3. The lure employed was Octenal, trans-2-octen-1 al, (3.8 microliters of Octenal dissolved in 1.393 mL of nonane). In each experiment, 50 bed bugs were placed in the arena and the number of bed bugs present in the harborage after 2 hours was recorded. The exposed area, i.e., the traversable surface of the harborage (which was molded from ABS) was modified as indicated below.

As a comparison Example A was run employing the identical lure but having a deadfall trap contained within the cover housing, but with no harborage. Each experiment was run twice with the average results being presented in the following Table.

| Example or | | |
|---|---|---|
| Comparative | | Bed Bugs in |
| Experiment | Trap/harborage Composition | Trap/harborage |
| A | Deadfall trap (no harborage) | 4/50 |
| 2-1 | Untreated ABS | 5/50 |
| 2-2 | Wire Brushed ABS | 16/50 |
| 2-3 | Glue/Kaolin Painted ABS | 24/50 |
| 2-4 | PVA/Kaolin Painted ABS | 22/50 |

The Glue/Kaolin binder mixture was prepared by adding 30 grams of kaolin (having an average particle size of 5-10 micrometers) to 100 mL of a mixture composed of (a) 40 weight percent of a water-based adhesive (Henry 430 ClearPro available from W.W. Henry Co.) and (b) 60 weight percent deionized water. The PVA/Kaolin binder mixture was prepared by adding 10 grams of kaolin and 3 grams of polyvinyl alcohol PVA (Celvol 24-203) into a vessel and adding deionized water until a total volume of 100 mL was present.

The above data shows that roughening the exposed surface of the substrate of the harborage to form a traversable surface will greatly increase the number of bed bugs which will enter into the harborage. Such data also demonstrates the unexpectedly improved results when a substrate is treated in accordance with the process of this invention.

### Example 3

A planar coupon measuring 1.5 inch by 2.0 inches was prepared by molding polypropylene containing 20 percent by weight of glass particles (“PP-G”). The average surface roughness of the coupon was measured using a Mahr Pocket Surf® portable roughness gage. The coupon was placed onto an inclined holder at about a 70 degree angle. An adult bed bug (Cimex lectularius) was placed onto the center of the coupon and visually monitored for about 5 minutes to determine if the bed bug was able to walk/climb the surface or was unable to hold onto the surface and fell off.

Additional coupons composed of polyethylene (“PE”); polypropylene (“PP”) that had been sanded with 100 grit sandpaper; and high density polyethylene (35 melt) (“HDPE”) were also evaluated. The results of the evaluation are summarized below:

| Surface | Average Roughness (μm) | Climbable by Bed Bugs |
|---|---|---|
| PP-G | 2.468 | Yes |
| Sanded PP | 3.100 | Yes |
| PE | 2.294 | No |
| HDPE | 0.214 | No |

The above results show that bed bugs will climb surfaces having an average surface roughness of at least about 2.5 micrometers, but will not climb surfaces having an average surface roughness of less than about 2.3 micrometers.

### Example 4

Planar coupons of polypropylene or polyethylene measuring 1.5 inch by 2.0 inches were prepared by painting the surface with the binder mixture indicated below; and drying the surface (either by allowing the surface to air dry or by using a heat gun as indicated in the Table below—mixtures were air dried unless noted otherwise).

Binder formulations comprising glue (Henry 430 ClearPro available from W.W. Henry Co.) were prepared by mixing the weight percentage of glue listed with a sufficient weight percent of deionized water to form a 100% mixture (e.g., the 40% glue formulation comprised 40 weight percent glue and 60 weight percent deeionized water). Binder formulations comprising a glue binder formulation and a particulate were prepared by adding the number of grams of particulate equivalent to the percentage listed to 100 mL of the glue formulation indicated (e.g., the 40% glue+20% pumice binder was formed by adding 20 grams of pumice to a composition comprising 40 weight percent glue and 60 weight percent deionized water).

The polyvinyl alcohol (PVA)(Celvol 24-203) compositions were prepared by adding the number of grams of PVA and particulate equivalent to the percentage listed to a graduated vessel and adding deionized water until a total volume of 100 mL was present. Thus, the 24% PVA and 20% pumice composition was formed by adding 24 grams of PVA and 20 grams of pumice to a graduated vessel and adding sufficient deionized water to produce a total volume of 100 mL.

The sprinkled coupons were prepared by first coating the coupon with the adhesive and then sprinkling a thin coating of the particulate indicated before the adhesive had dried.

The kaolin employed had an average particle size d (0.9) of 5-10 micrometers. The cellulose employed (fibrous, medium) was Catalogue #C6288 available from Sigma-Aldrich; while the pumice employed was Polishing Powders #23.402 available from Grobet, USA.

Each coupon was placed onto an inclined holder at about a 70 degree angle. Adult bed bugs (Cimex lectularius) were placed onto the center of the coupon and visually monitored for about 5 minutes to determine if the bed bugs were able to walk/climb the surface or were unable to hold onto the surface and fell off. The results of the evaluation are summarized below:

| | Traversable |
|---|---|
| Surface | by Bed Bugs |
| 10% Glue | no |
| 20% Glue | no |
| 30% Glue | no |
| 40% Glue | no |
| 50% Glue | no |
| 60% Glue | *yes |
| 70% Glue | *yes |
| 20% Glue + 10% Kaolin | yes |
| 30% Glue + 10% Kaolin | yes |
| 40% Glue + 10% Kaolin | yes |
| 50% Glue + 10% Kaolin | yes |
| 60% Glue + 10% Kaolin | yes |
| 40% Glue + 10% Pumice (Heat dried) | yes |
| 40% Glue + 10% Pumice (Air dried) | yes |
| 40% Glue + 20% Pumice (Heat dried) | yes |
| 40% Glue + 20% Pumice (Air dried) | yes |
| 40% Glue + 30% Pumice (Heat dried) | yes |
| 40% Glue + 30% Pumice (Air dried) | yes |
| 50% Glue + 10% Pumice (Heat dried) | yes |
| 50% Glue + 20% Pumice (Heat dried) | yes |
| 50% Glue + 20% Pumice (Air dried) | yes |
| 50% Glue + 30% Pumice (Heat dried) | yes |
| 50% Glue + 30% Pumice (Air dried) | yes |
| 60% Glue + 10% Pumice (Heat dried) | yes |
| 60% Glue + 10% Pumice (Air dried) | yes |
| 60% Glue + 20% Pumice (Air dried) | yes |
| 60% Glue + 30% Pumice (Air dried) | yes |
| 60% Glue + 30% Pumice (Heat dried) | yes |
| 60% Glue + Pumice (Sprinkled on-Heat | yes |
| dried) | |
| 40% Glue + 10% Cellulose (Heat dried) | yes |
| 40% Glue + 10% Cellulose (Air dried) | yes |
| 40% Glue + Cellulose (Sprinkled on-Heat | yes |
| dried) | |
| 50% Glue + Cellulose (Sprinkled on-Heat | yes |
| dried) | |
| 50% Glue + Cellulose (Sprinkled on-Air | yes |
| dried) | |
| 60% Glue + Cellulose (Sprinkled on-Heat | yes |
| dried) | |
| 60% Glue + Cellulose (Sprinkled on-Air | yes |
| dried) | |
| 20% PVA + 30% Kaolin (Air dried) | yes |
| 20% PVA + Pumice (Sprinkled on-Air | yes |
| dried) | |
| 20% PVA + Pumice (Sprinkled on-Heat | yes |
| dried) | |
| 20% PVA + Cellulose (Sprinkled on-Heat | yes |
| dried) | |
| 24% PVA + 20% Pumice (Heat dried) | yes |
| 24% PVA + 20% Pumice (Air dried) | yes |
| 24% PVA + 30% Pumice (Air dried) | yes |
| 24% PVA + Pumice (Sprinkled on-Air | yes |
| dried) | |
| 24% PVA + Pumice (Sprinkled on-Heat | yes |
| dried) | |
| 24% PVA + 20% Kaolin (Heat dried) | yes |
| 24% PVA + 20% Kaolin (Air dried) | yes |
| 24% PVA + Cellulose (Sprinkled on) | yes |

*while the bed bugs were able to climb the 60% and 70% glue formulations with some difficulty, it is believed that this was because the formulations had not completely dried and therefore remained tacky enough for the insects to traverse the surfaces.

### Example 5

Polyvinyl alcohol solutions were prepared by dissolving 60 grams (6%), 30 grams (3%) or 15 grams (1.5%) of PVA (Celvol 24-203), as indicated below, into 1 liter of deionized water. To 100 mL of each PVA solution was added ten grams of an inert solid. The test PVA mixtures were painted onto polypropylene (PP) or polyethylene (PE) plastic coupons, measuring about 1.5 inches by 2 inches, and were allowed to air dry. The kaolin employed had an average particle size d(0.9) of 5-10 micrometers; while the carborundum employed had an average particle size d(0.9) of about 45 micrometer. The pumice employed was Polishing Powders #23.402 available from Grobet, USA.

The treated coupons were placed onto an inclined holder at about a 70 degree angle. An adult bed bug, BB, (Cimex lectularius) was placed onto the center of the treated surface and visually monitored for about 5 minutes to determine if the insect was able to walk/climb the surface or was unable to hold onto the surface and fell off. The results of the testing are summarized below:

| Plastic | % PVA in | Inert Solid | Traversable by |
|---|---|---|---|
| in Coupon | test mixture | (10% w/v) | Bed Bugs |
| PP | 6 | None | No |
| PP | 3 | None | No |
| PP | 1.5 | None | No |
| PE | 6 | None | No |
| PE | 3 | None | No |
| PE | 1.5 | None | No |
| PP | 6 | Pumice | Yes |
| PP | 3 | Pumice | Yes |
| PP | 1.5 | Pumice | Yes |
| PE | 6 | Pumice | Yes |
| PE | 3 | Pumice | Yes |
| PE | 1.5 | Pumice | Yes |
| PP | 6 | Carborundum | Yes |
| PP | 3 | Carborundum | Yes |
| PP | 1.5 | Carborundum | Yes |
| PE | 6 | Carborundum | Yes |
| PE | 3 | Carborundum | Yes |
| PE | 1.5 | Carborundum | Yes |
| PP | 6 | Kaolin | Yes |
| PP | 3 | Kaolin | Yes |
| PP | 1.5 | Kaolin | Yes |
| PE | 6 | Kaolin | Yes |
| PE | 3 | Kaolin | Yes |
| PE | 1.5 | Kaolin | Yes |

1-37. (canceled)

38. A bed bug monitoring device comprising: (a) a bed bug attractant element; and (b) a harborage comprising a support member having a traversable surface and one or more protuberances thereon, the harborage being adapted to be placed flush with the surface where the device will be placed.

39. The device of claim 38, wherein the one or more protuberances define one or more channels.

40. The device of claim 38, wherein the traversable surface has an average surface roughness of at least 2.5 micrometers.

41. The device of claim 38, wherein the harborage further comprises a base section, at least a portion of the base section comprising a transparent material and being adapted to be placed flush with the surface where the device will be placed.

42. The device of claim 41, wherein the base section comprises polycarbonate.

43. The device of claim 39, wherein the one or more protuberances are spaced to form channel widths of between 2 mm and 10 mm.

44. The device of claim 39, wherein the one or more channels have a top surface that is concave in cross section.

45. The device of claim 40, wherein the exposed area of the traversable surface possesses an average surface roughness of at least 3.0 micrometers.

46. The device of claim 38, wherein the support member comprises a material selected from the group consisting of acrylonitrile butadiene styrene and high impact polyethylene.

47. The device of claim 38, wherein at least a portion of the exposed area of the traversable surface is coated with a binder mixture comprising an adhesive and particulate solid.

48. The device of claim 47, wherein the adhesive comprises a water-based adhesive.

49. The device of claim 48, wherein the water-based adhesive comprises a material selected from the group consisting of polyvinyl alcohol, cellulose ethers, methylcellulose, carboxymethylcellulose and polyvinylpyrrolidone.

50. The device of claim 47, wherein the particulate solid comprises a material selected from the group consisting of pumice, carborundum, kaolin, silica, sand, cellulose and talc.

51. A method for providing a traversable surface for bed bugs having a surface roughness of at least 2.5 micrometers comprising the steps of: (a) applying to the surface of a suitable support member a binder mixture comprising an adhesive and a particulate solid; and (b) drying the mixture.

52. The method of claim 51, wherein the adhesive comprises a water-based adhesive.

53. The method of claim 51, wherein the particulate solid comprises a material selected from the group consisting of pumice, carborundum, kaolin, silica, sand, cellulose and talc.

54. The method of claim 51, wherein the support member comprises a material selected from the group consisting of polyethylene, polypropylene, and acrylonitrile butadiene styrene.

55. The method of claim 52, wherein the water-based adhesive comprises a material selected from the group consisting of polyvinyl alcohol, cellulose ethers, methylcellulose, carboxymethylcellulose and polyvinylpyrrolidone.

56. The method of claim 52, wherein the water-based adhesive is present in an amount between 1% and 70% by weight, based upon the total weight of the adhesive and water present.

57. The method of claim 51, wherein inert particulate solid has an average particle size of between 5 and 50 micrometers.
